(19) United States
(12) Patent Application Publication
(10) Pub. No.: US 2007/0268784 A1
(43) Pub. Date: Nov. 22, 2007

(54) Alarm Clock Having Triple Weekly Alarms

(76) Inventor: Hongtao Xu, McKinney, TX (US)

Correspondence Address: HONGTAO XU, 2905 CYPRESS POINT DRIVE, MCKINNEY, TX, 75070, US

(21) Appl. No.: 11/747,228

(22) Filed: May 10, 2007

Related U.S. Application Data
(60) Provisional application No. 60/800,996, filed on May 17, 2006.

(51) Int. Cl. G04C 21/00; G04B 23/02; G04C 23/00

(52) U.S. Cl. 368/73

(57) ABSTRACT

An alarm clock apparatus comprises of a control unit, a plurality of buttons for selecting one or more alarm times on one or more selected days of a week, a display comprising a plurality of displaying areas for displaying current time, date, the day of the week for current date, and one or more selected alarm times on one or more selected days of the week, an alarm unit, and a power unit.

### CROSS REFERENCE TO RELATED APPLICATIONS

This patent application claims the benefit of U.S. Provisional Patent Application Ser. No. 60/800,996, filed on May 17, 2006, which is hereby incorporated by reference.

### FIELD OF THE INVENTION

The present invention relates to an alarm clock. More specifically, the present invention relates to an alarm clock capable of being set for different alarm times for weekdays, Saturdays and Sundays and display for displaying current time, weekday alarm time, Saturday alarm time or Sunday alarm time on different areas of a display.

### BACKGROUND OF THE INVENTION

Most alarm clocks in use can be set one daily alarm time that activates everyday to generate an alarm sound. For example, one can set a wake-up time on an alarm clock at 6:00 AM. The wake-up time is set and activated the same time for everyday, unless being re-set a different wake up time or being deactivated. If a person deactivates the daily alarm on weekend and forget re-activating the daily alarm setting on weekdays, the alarm clock will fail to produce a daily alarm sound. If a person forgets deactivating the daily alarm on weekend, the alarm clock may produce an undesirable alarm sound on weekend mornings. To avoid being accidentally woken up on Saturday morning, or even worse, being late on Monday morning, a user has to remember to turn the alarm on or off twice a week, or a total of 104 times each year.

U.S. Pat. No. 4,487,512 disclosed a programmable alarm clock having seven switches for selecting any of the seven days of the week in which an alarm may be sounded. The alarm clock can be selectively activated/deactivated on any day of the week. However, the alarm clock disclosed in the '512 patent capable being set only a single alarm time for different days in the week.

Most people have different weekend schedules from their weekday schedules. For example, most company employees and school students have a fixed Monday through Friday schedule, and churchgoers have a fixed but different Sunday schedule. Those people need weekly recurring alarms to wake them up in order to go to the workplace, school and church on time. On the other hand, the Saturday schedule is usually quite variable, not fixed. In fact, there are a lot of Saturday sleepers who want to get up late without an alarm wakeup, but unfortunately Saturday is likely the day when people receive most unexpected alarms by mistake.

The alarm clock disclosed in the '512 patent has seven activation/deactivation buttons in order for a user to select the same alarm time in any day of the week. Some recent alarm clocks simplified the seven button design of the '512 patent to have a weekend button to silence the alarm for the weekend, which essentially disables both Saturday and Sunday. In the real world, a Sunday alarm may often need to be on for churchgoers, but usually the weekend alarm, which includes Saturday and Sunday, is disabled by Saturday morning sleepers. When the Sunday alarm is disabled with the weekend button, a person needs to wake up on Sunday at certain time may miss the wake up time. For example, a churchgoer could be late for church on Sunday.

### SUMMARY OF THE INVENTION

Accordingly, it would be highly desirable to provide an alarm clock capable of being set different alarm times on different days of the week. One objective of the present invention is to provide such an alarm clock to minimize user intervention by distinguishing fixed schedules and setting up weekly, thereby reducing accidental activation of an undesirable alarm sound and accidental deactivation of a desirable alarm. An alarm clock is provided in the present invention, which is easy for a user to set up a workdays alarm and one or more different weekend alarms. A further objective of the present invention is to provide an alarm clock for setting up a weekdays alarm and a different Sunday alarm.

Another objective of the present invention is to provide easy functional buttons of operating the alarm clock. A further objective is to provide a user with easy buttons to set up different alarm times for weekdays, Saturdays and Sundays.

Yet another objective of the present invention is to provide a clear display of alarm schedules and status to avoid user confusions. A further objective is to provide different display areas for displaying current time, weekday alarm time, Sunday alarm time, and/or Saturday alarm time.

The current invention is related to an alarm clock apparatus comprising a control unit for receiving and storing a user inputs and managing the system timing functions, Including but not limiting to, setting current time, date and day of the week, storing a calendar including automatically adjusting Daylight Saving Time, setting different alarms for different days of the week, selecting alarm types including sound, light and motion, setting alarm durations, frequencies and alarm sound volume, controlling display modes, activating or deactivating alarms, and alerting a user when battery power is low; a plurality of buttons for selecting one or more alarm times on an hour and minute basis on one or more selected days of a week; a display comprising a plurality of displaying areas for displaying current time on an hourly and minute basis, the day of the week for current date, and for displaying one or more selected alarm times on an hourly and minute basis on one or more selected days of the week; an alarm unit; and a power unit for providing power to said control unit, said display unit and said alarm unit.

### BRIEF DESCRIPTION OF THE FIGURES

FIG. 1 illustrates a circuit diagram of an alarm clock of the present invention.

FIGS. 2a, 2b and 2c illustrate a flow chart of the alarm setting functions of the present invention.

FIG. 3 illustrates the three-dimensional perspective view of an alarm clock of the present invention.

FIG. 4 illustrates the display panel of the front view of an alarm clock of the present invention.

FIG. 5 illustrates the top view of the alarm clock related to FIG. 4.

FIG. 6 illustrates the rear view of the alarm clock related to FIG. 4.

FIG. 7 illustrates the front view of another alarm clock of the present invention.

FIG. 8 illustrates the rear view of the alarm clock related to FIG. 7.

FIG. 9 illustrates the top view of the alarm clock related to FIG. 7.

### DETAILED DESCRIPTION OF EXEMPLARY EMBODIMENTS

It should be appreciated that the particular implementations shown and described herein are examples of the invention and are not intended to otherwise limit the scope of the present invention in any way.

The alarm clock of the present invention comprises of following units:

1. Control Unit. This is the central unit that receives and stores a user inputs and manages the system timing functions, Including but not limiting to, setting current time, date and day of the week, storing a calendar including automatically adjusting Daylight Saving Time, setting different alarms for different days of the week, selecting alarm types including sound, light and motion, setting alarm durations, frequencies and alarm sound volume, controlling display modes, activating/deactivating alarm, and alerting a user when battery power is low. The control unit usually comprises of an electric circuit, logics and memory, but may vary depending on available technology.

2. Alarm Unit. This is the unit receiving an alarm command is received from the control unit to produce an alarm. Alarm types comprises of sound, light or motion. The alarm unit comprises of an alarm generator which can be a mechanical type and an electrical type and activated to generate an alarm by an electrical signal or a mechanical signal according to the alarm command received from the control unit.

3. Display Unit. This is the unit for displaying the current time/date, user inputs, alarm setting and other system messages. The display unit comprises of a display panel which may be a LCD, LED or other display types. The current time is displayed either in 12-hour notation with an AM/PM indicator, or 24-hour notation.

4. Function Buttons. A user communicates with the alarm clock using the function buttons. The user can input or adjust the date and time, set up alarm(s), select display modes, and turn alarm(s) on/off.

5. Power Unit. This is usually either a battery compartment or an electric power supply. Batteries can vary in size for different purposes.

6. Housing. This is the container to hold all of the above units working together. Housing can vary in size, shape, color and material, depending on different marketing needs.

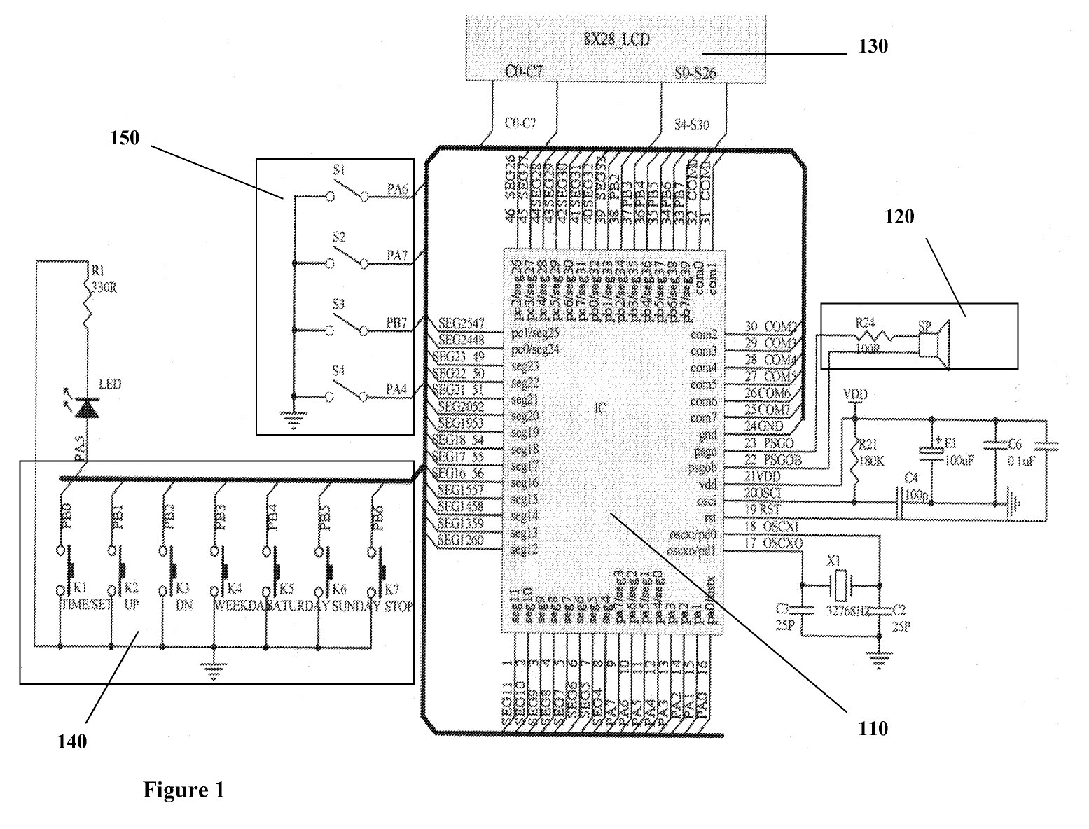

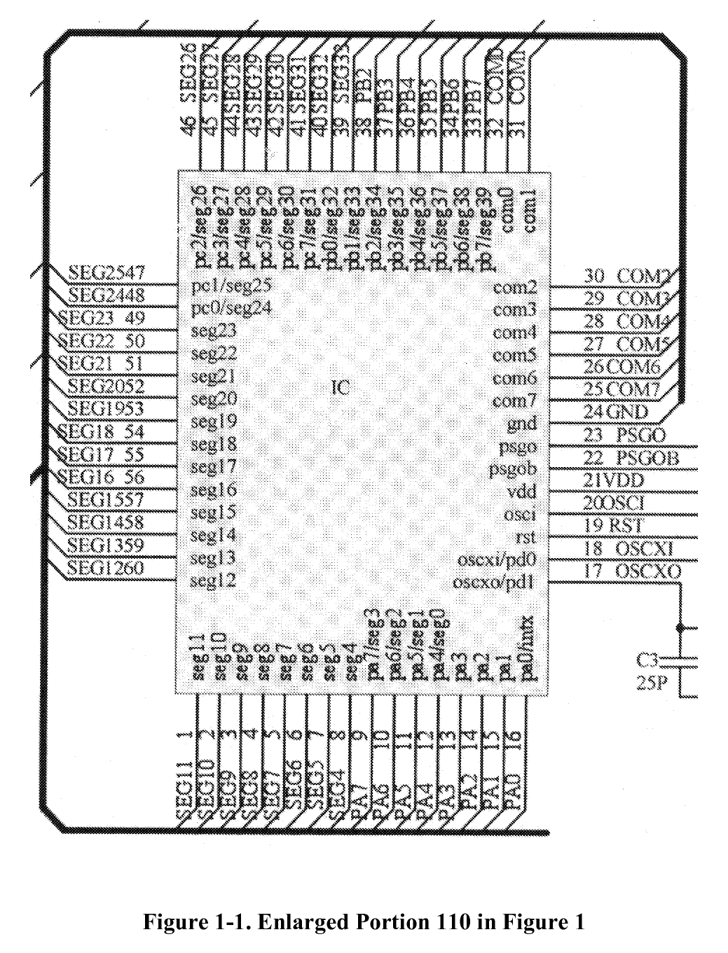

FIG. 1 illustrates an exemplary circuit diagram of an alarm clock of the present invention. The alarm clock comprises a control unit 110, an alarm unit 120, a display panel 130, function buttons 140 (K1, K2, K3, K4, K5, K6, and K7), system default settings internal switches 150 such as day light saving time and 12/24 hour settings, and a battery (no shown). When a user presses and hold function button function buttons K1 (Time/Date Set button) for a short duration, such as 3 seconds, the control unit 110 is set into receiving the user input for setting current time and date, starting from the current hour. The user presses the K2 (Up) and K3 (down) buttons to adjust the current time to the correct hour, then presses the K1 button once again for setting the control unit 110 into the current minute input mode. Similar sequences can be applied to adjust the current minute, month, day and year. For example, after the minute is set, the user presses the K1 button once again for setting the control unit 110 into the current month input mode. The sequences illustrated are only exemplary and various methods can be used for setting current time and date. The control unit comprises of a memory for storing a calendar having a calculator with a correlation for converting an inputted date to the day of the week, for example, the date of Dec. 25, 2005 is converted to be Sunday. When a current date is correctly adjusted, current day of the week is automatically converted and the current time, date, and day of the week are stored in the memory. Function buttons K4, K5, K6 allow a user to set weekly alarms for weekdays, Saturdays and Sundays, respectively. The control unit 110 further comprises of a logic unit for performing comparison functions for determining which button is pressed or held for a short duration. When one of the buttons K4, K5, K6 is pressed, the automatically determines which mode, alarms for weekdays, Saturdays or Sundays, is to be set.

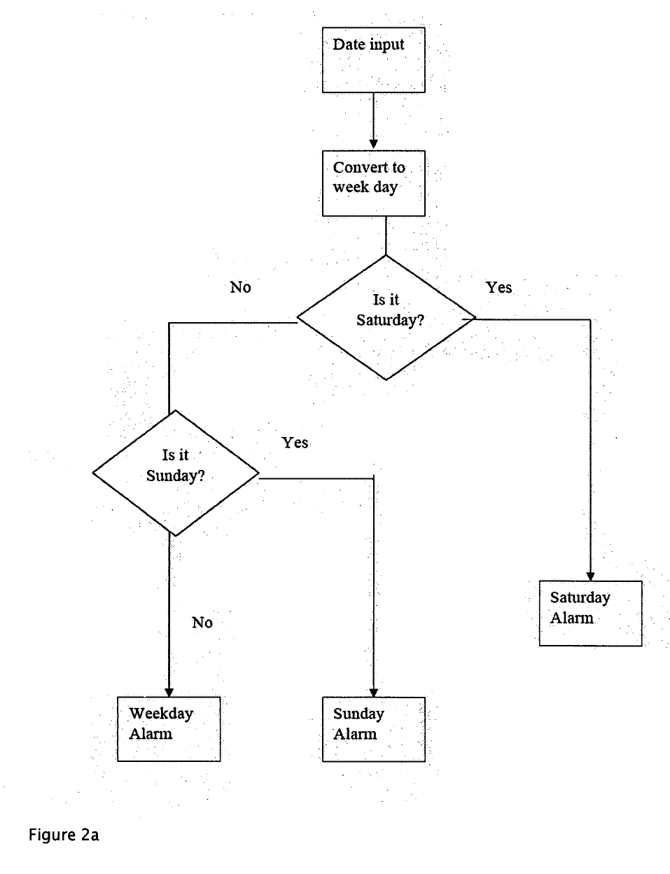

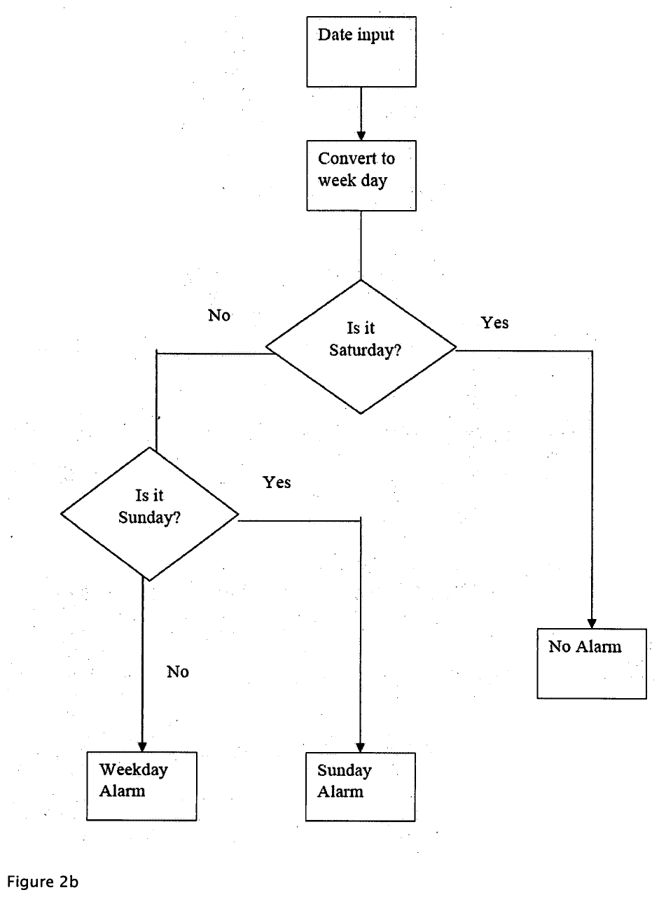

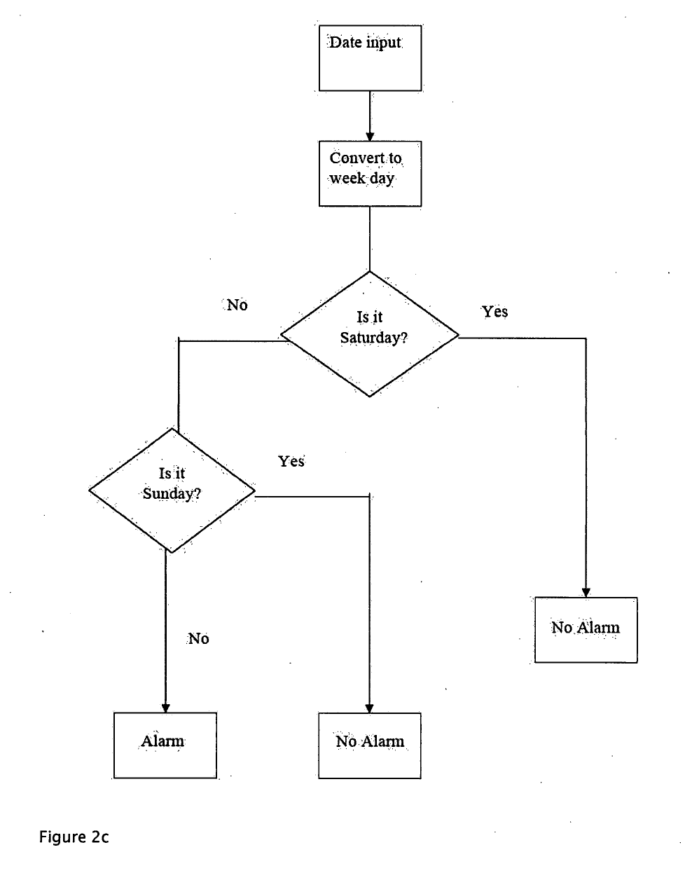

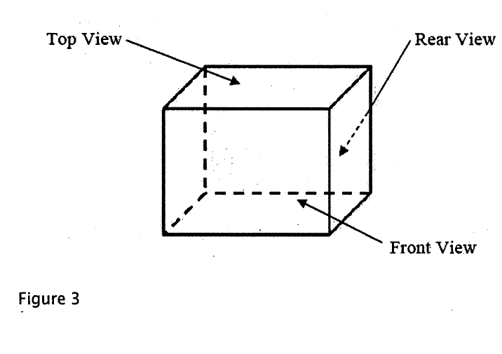

FIGS. 2a, 2b, and 2c illustrate different operation modes of the control unit 110 at different configurations and setting. The control unit 110 determines whether current day is a weekday, a Saturday or a Sunday. FIG. 2a illustrates the control unit 110 is set to enable three different alarm times, weekdays, Saturdays and Sundays. The control unit 110 determines current date to be a weekday, Saturday or Sunday and switches to the corresponding alarm time for a weekday, Saturday or Sunday, respectively. FIG. 2b illustrates the control unit 110 is set to enable an alarm on each weekday and Sunday, and disable the Saturday alarm. FIG. 2c illustrates the control unit 110 is set to enable an alarm on each weekday, and disable alarms for the weekend. The Saturday and Sunday alarms can be selected as “one-time-only”, or recurring every week.

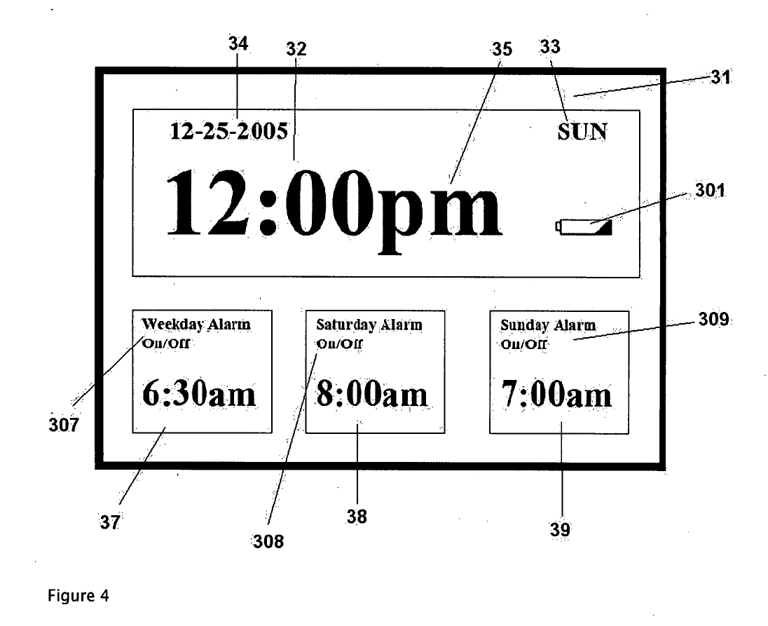

FIG. 4 illustrates the display panel of the front view of an alarm clock of the present invention. The display panel comprises of four display areas comprising of LCDs or LEDs, area 31 for displaying current time 32, current day of the week 33, current date 34, and battery power level indicator 301, area 37 for set alarm time for weekdays and alarm on/off status 307, area 38 for set alarm time for Saturdays and alarm on/off status 308, and area 39 for set alarm time for Sundays and alarm on/off status 309.

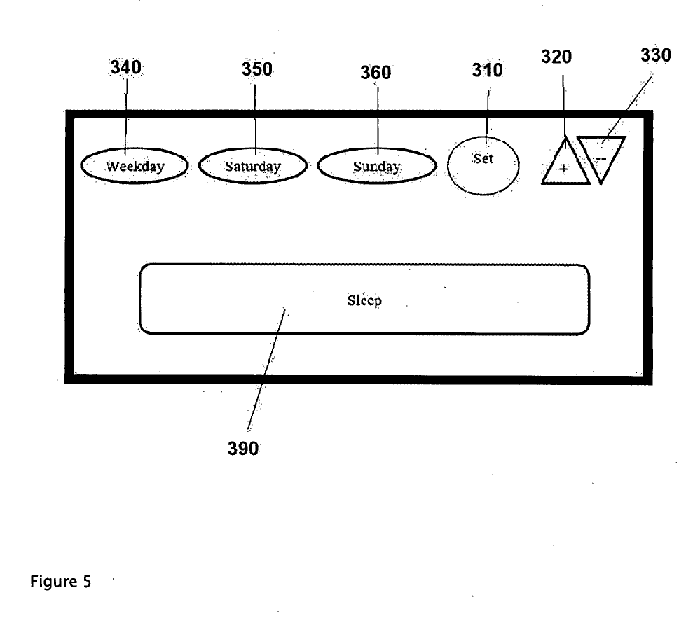

FIG. 5 illustrates the top view of the alarm clock related to FIG. 4. Buttons 340, 350, and 360 are for setting alarm times for weekdays, Saturdays and Sundays, respectively. Set button 310 is for setting the current date and time, including the month, day, year and am/pm settings. The Set button is used associated with the (+) button 320 and (−) button 330 for adjusting the current correct time using a similar sequences as described above. The sleep button 390 is for snoozing and/or stopping a current alarm without affecting the alarm time settings.

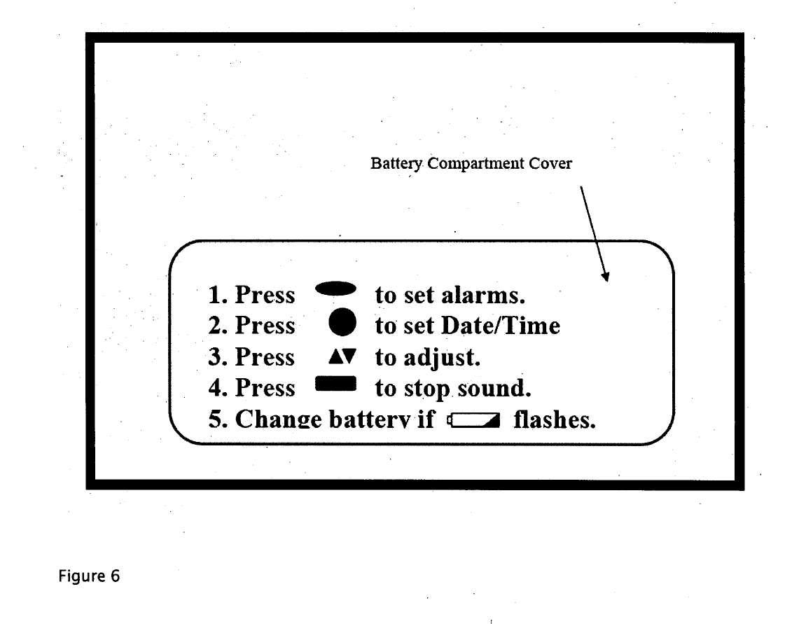

FIG. 6 illustrates the rear view of the alarm clock related to FIG. 4, showing the battery compartment, with easy instructions imprinted on the battery compartment cover.

When button 340 is pressed once by a user, the weekdays alarm is switched between “on” and “off” status. When a user presses and holds button 340 for short duration of time, for example for 3 seconds, the control unit 110 is set for weekdays alarm setting status. The user can use the buttons 320 and 330 to adjust the correct alarm time for weekdays. Similar procedures by pressing and/or holding buttons 350 and 360 can be used for setting alarm times for Saturdays and Sundays, respectively. The alarm times set for weekdays, Saturdays and Sundays are displayed in display areas 37, 38, and 39 respectively as illustrated in FIG. 4. Alternatively, alarm times can be set for weekdays only, weekdays and Sundays only, weekdays and Saturdays only, Saturdays only, Sundays only, or Saturdays and Sundays only, with corresponding alarm time displayed in the corresponding area. In an embodiment, the respective alarm time or times is displayed in the respective display area, 37, 38, or 39 when the alarm is set for weekdays, Saturdays, or Sundays. Yet another embodiment for a user having a fixed weekdays schedule and a fixed but different Sundays schedule is to set the alarm for Saturdays in an “off” status, wherein the display area 38 displays “off” status which can be blank or with word “off”, “Saturday alarm off”, or any other relevant messages. For a user having a fixed weekdays schedule and a fixed but different Saturdays schedule is to set the alarm for Sundays in an “off” status, wherein the display area 39 display “off” status, and the display area 38 displays an set alarm time for Saturdays. The various alarm setting modes and alarm status display modes provide a user a clear and precise message without any ambiguity, which greatly reduces mistakenly set or unset alarms.

Another embodiment for a user who needs an occasional Saturday alarm is to set the alarm time in a one-time only fashion. To achieve the “one-time only” alarm for the Saturday in the week while keeping weekly recurring weekdays and/or Sundays alarms, switch S2 in circuit diagram in FIG. 1 is set to the “off” status. When the switch S2 is set to the “on” status, the Saturday alarm is set to the weekly recurring state.

Battery power level is measured by the control unit 110 and displayed in a proportional manner in the power level indicator 301. When battery power is low, power level 301 will flash to alert a user for changing the battery.

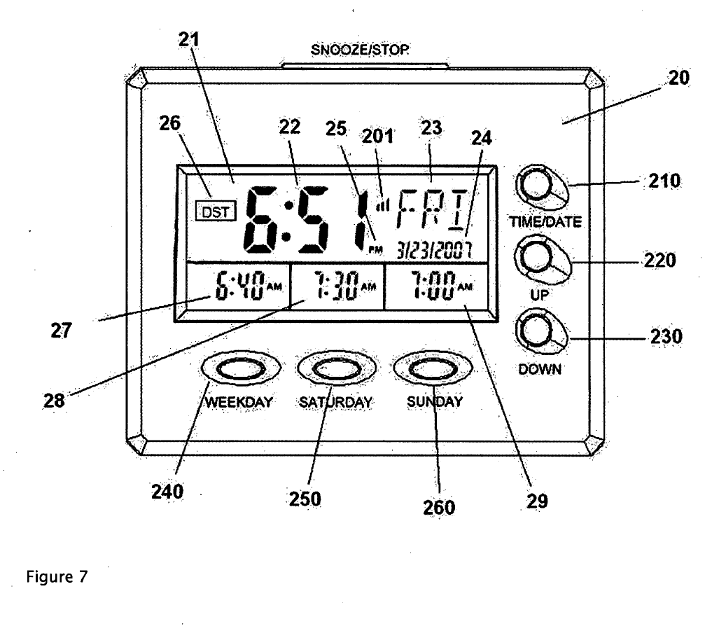

FIG. 7 illustrates the front view of another embodiment of the present invention. The display panel 21 comprises of a display comprising of LCDs or LEDs, wherein the display further comprises of a plurality of display areas for displaying various system messages, including current time, date, day of the week, set alarm times for weekdays, Saturdays, and Sundays, alarm sound volume indicator (201), and Daylight Saving Time indicator (26). When switch S4 illustrated in FIG. 1 is set to the “On” status, the control unit 110 automatically adjusts the current time and alarm time or times according to Daylight Saving Time (DST) and a DST indicator is displayed in display area 26 when current time and date falls in the Daylight Saving Time. The Daylight Saving Time mode is disabled when the switch S4 is set in the “Off” status to accommodate users living in areas not using Daylight Saving Time. To adjust the sound volume, a use presses button 220 (Up) or button 230 (Down) for a short duration, for example, for 3 seconds, to set the control unit 110 into an alarm sound setting mode. The used then uses button 220 and/or button 230 to adjust the desired alarm sound volume. The set alarm sound volume is display in area 201, which is illustrated as level bars as shown in FIG. 7.

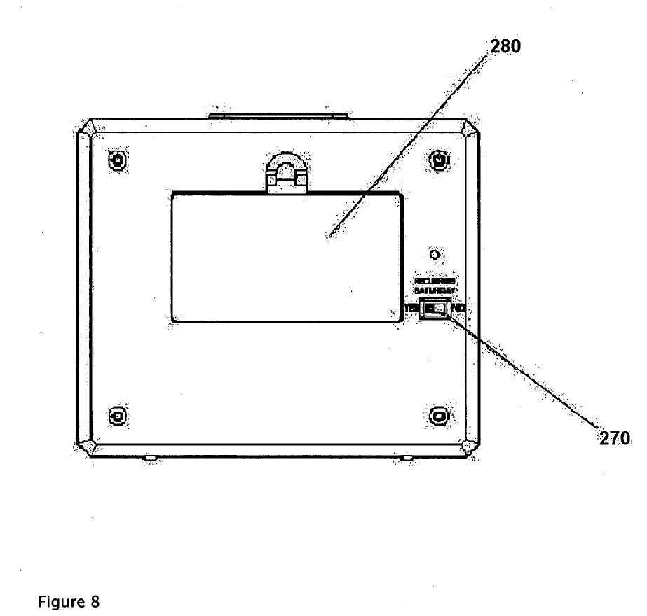

FIG. 8 illustrates the rear view of the alarm clock related to FIG. 7, showing a switch 270 for selecting Saturday alarm “weekly recurring” or “one-time only” mode, and a battery compartment 280. When the switch 270 is turned to “weekly recurring” mode, the switch S2 illustrated in FIG. 1 is in “On” status to enable the alarm clock to produce weekly recurring alarms on Saturdays. When the switch 270 is turned to “one-time only” mode, the switch S2 is in “Off” status, wherein the alarm clock produces an alarm on the incoming Saturday only and the Saturday alarm and its display in display area 28 are automatically turned off after the Saturday alarm is activated.

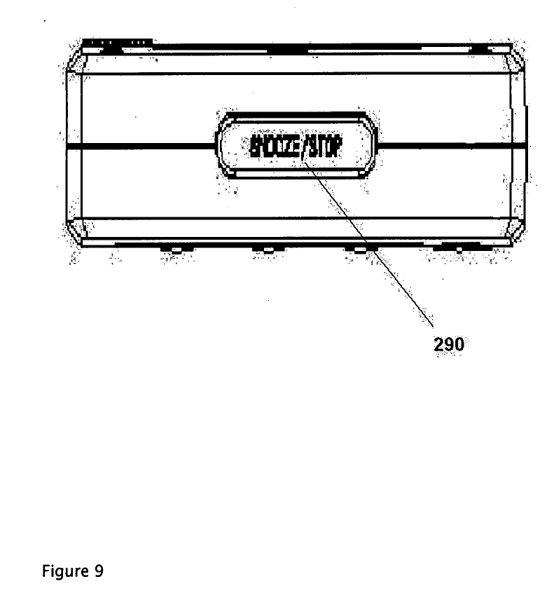

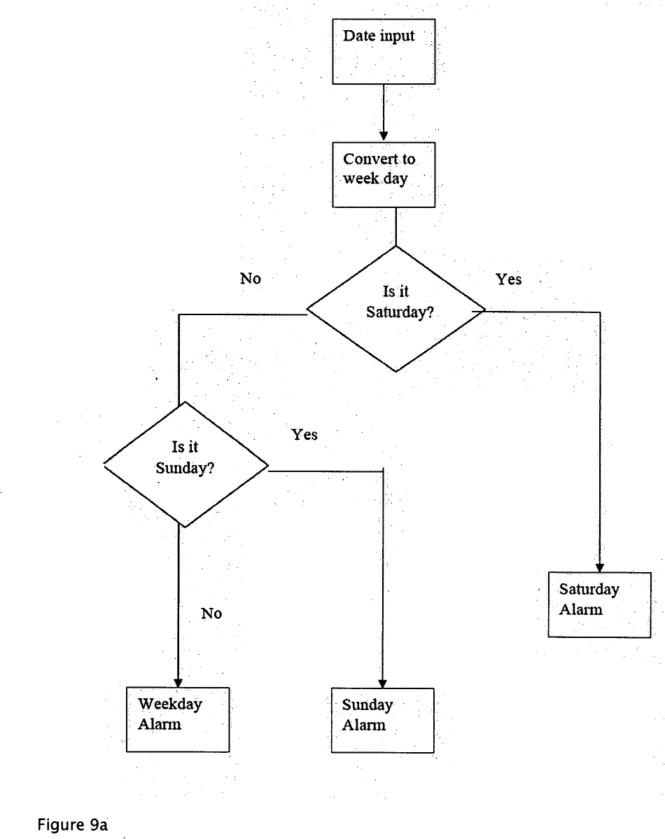

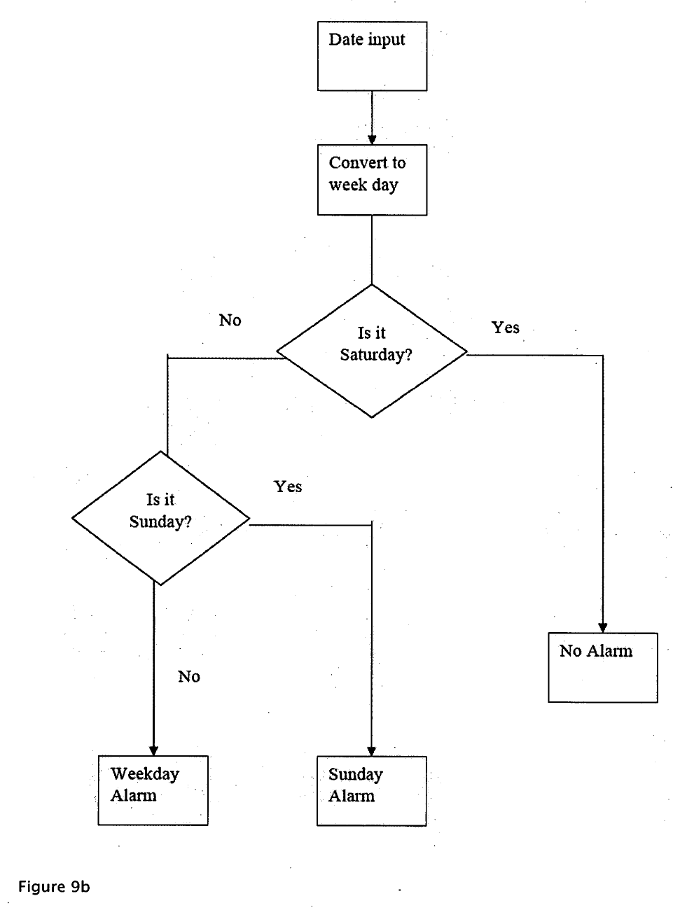

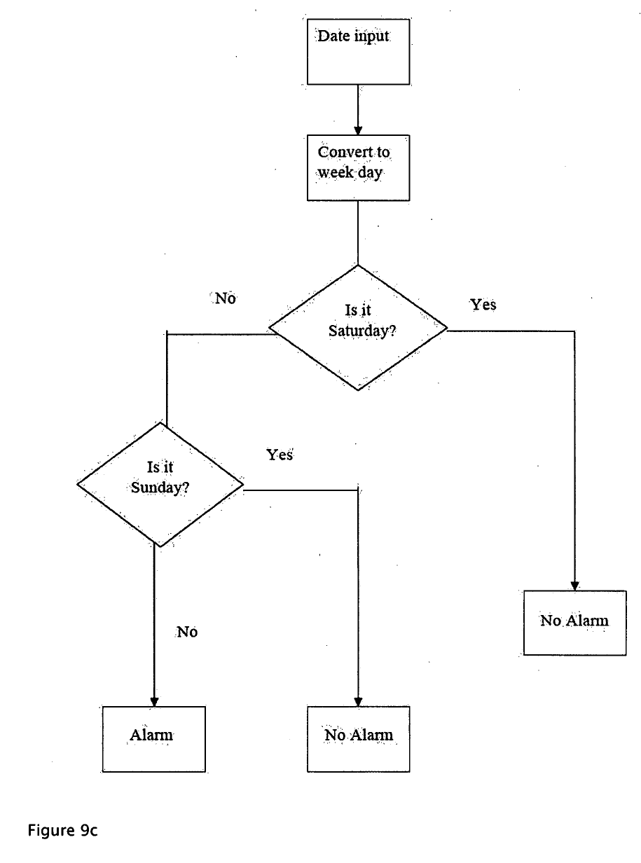

FIG. 9 illustrates the top view of the alarm clock related to FIG. 7, showing a Snooze/Stop buttons 290.

Another embodiment of the current invention comprises of an alarm clock comprising a button for setting a weekdays alarm and another button for setting Sunday alarm, wherein the control unit is set to disable Saturday alarms. An exemplary alarm has a button for setting a weekdays alarm and another button for setting Sunday alarm, without a need of a third button for setting Saturday alarm. The control unit 110 determines whether current day is Saturday and disable the alarm if the current day is Saturday, using the logic flow as illustrated in FIG. 2b.

Yet another embodiment of the current invention comprises of an alarm clock comprising a button for setting a weekdays alarm and another button for setting Saturday alarm, wherein the control unit is set to disable Sunday alarms. The control unit 110 determines whether current day is Sunday and disable the alarm if the current day is Sunday.

Another embodiment of the current invention comprises of an alarm clock comprising a button for setting a daily alarm, without the need for a second and a third button for deactivating the Saturday and Sunday alarms, wherein the control unit is set to disable weekend alarms. The control unit 110 determines whether current day is Saturday or Sunday and disable the alarm if the current day is Saturday or Sunday, using the logic flow as illustrated in FIG. 2c.

It will be understood that many other embodiments and combinations of difference choices of materials and arrangements could be formulated without departing from the scope of the invention. For example, the weekdays alarm can be replaced with five single day alarms from Monday to Friday. Alarm times for weekdays can be displayed separately with five separate displaying areas. The scope of the invention should be determined by the appended claims and their legal equivalents, rather than by the examples given above.

### REFERENCE

[1] U.S. Pat. No. 4,487,512, Price; I. Garth

What is claimed is:

1. An alarm clock apparatus, comprising,
a housing;
a control unit;
a plurality of buttons comprising a first button of said plurality of buttons for selecting a first alarm time on an hour and minute basis on a first selected day of a week;
a display comprising a plurality of displaying areas, wherein a first area of the said display areas for displaying time on an hourly and minute basis, a second displaying area of said display areas for displaying the day of the week for current date, and a third area of said display areas for displaying said first selected alarm time on an hourly and minute basis on said first selected day of the week;
an alarm unit for providing an audible alarm at said first selected alarm time on said first selected day of the week;
and a power unit for providing power to said control unit, said display unit and said alarm unit;
wherein said control unit for determining time on daily, hourly and minute basis, for storing said first selected alarm time, for controlling said display and said alarm unit, and for determining whether said current day is a weekday, a Saturday or a Sunday.

2. An alarm clock apparatus in claim 1, wherein said first selected day of the week is a weekday; wherein said control unit control said display to display said first selected alarm time in said third area of said display areas and said alarm unit to provide an audible alarm at said first selected alarm time on said selected weekday.

3. An alarm clock apparatus in claim 2, further comprising a second button of said plurality of buttons for selecting a second alarm time on an hour and minute basis on a Saturday or Sunday, a fourth area of said display areas for displaying said second selected alarm time on an hourly and minute basis on said selected Saturday or Sunday; wherein said control unit controls said alarm unit for providing an audible alarm at said second selected alarm time on said selected Saturday or Sunday; and wherein said second selected alarm time is different from said first selected alarm time.

4. An alarm clock apparatus in claim 2, further comprising a second button of said plurality of buttons for selecting a second alarm time on an hour and minute basis on a Saturday, a fourth area of said display areas for displaying said second selected alarm time on an hourly and minute basis on said selected Saturday, a third button of said plurality of buttons for selecting a third alarm time on an hour and minute basis on a Sunday, a fifth area of said display areas for displaying said third selected alarm time on an hourly and minute basis on said selected Sunday; wherein said control unit controls said alarm unit for providing an audible alarm at said second selected alarm time on said selected Saturday and an audible alarm at said third selected alarm time on said selected Sunday; and wherein at least one of the said second selected alarm time and said third selected alarm time is different from said first selected alarm time.

5. An alarm clock apparatus in claim 2, further comprising a sixth area of said display areas for displaying power level of said power unit.

6. An alarm clock apparatus in claim 2, further comprising a seventh area of said display areas for displaying a sound volume of said alarm unit.

7. An alarm clock apparatus in claim 3, further comprising a fifth button for selecting said control unit to control said alarm unit for providing an audible alarm at said second selected alarm time on one time only or weekly recurring on said selected Saturday or Sunday.

8. An alarm clock apparatus in claim 4, further comprising a fifth button for selecting said control unit to control said alarm unit for providing an audible alarm at said second selected alarm time on one time only or weekly recurring on said selected Saturday.

9. An alarm clock apparatus in claim 1, further comprising a sixth button for turning off said alarm unit.

10. An alarm clock apparatus in claim 1, further comprising a seventh button for selecting a sound volume of said alarm unit.

11. An alarm clock apparatus in claim 1, wherein said control unit disables aid alarm unit when said current day is determined to be a Saturday.

12. An alarm clock apparatus in claim 1, wherein said control unit disables aid alarm unit when said current day is determined to be a Saturday or a Sunday.

13. An alarm clock apparatus in claim 1, wherein said control unit automatically determines whether said current day falls in Daylight Saving Time period; and wherein display further comprises of an eighth area of said display areas for display whether said current day falls in Daylight Saving Time period.

15. An alarm clock apparatus in claim 13, further comprising an eighth button for selecting said control unit to enable or disable automatically adjusting based on said Daylight Saving Time.

16. An alarm clock apparatus in claim 1 3, wherein said control unit automatically adjusts said current time and said first selected alarm time based on said Daylight Saving Time.

17. An alarm clock apparatus, comprising,
a housing;
a display unit for display a current time;
a control unit for determining said time on daily, hourly and minute basis, for determining whether the current day is a weekday, a Saturday or a Sunday, for storing a first selected alarm time on an hour and minute basis on a first selected day of a week, for storing a second selected alarm time that is different from said first selected alarm time on an hour and minute basis on a second selected day of a week, and for controlling an alarm unit;
a plurality of buttons comprising a first button of said plurality of buttons for selecting said first selected alarm time on an hour and minute basis on said first selected day of a week, and a second button of said plurality of buttons for selecting said second selected alarm time that is different from said first selected alarm time on an hour and minute basis on said second selected day of a week;
an alarm unit for providing a first audible alarm at said first selected alarm time on said first selected day of the week, and/or providing a second audible alarm at said second selected alarm time on said second selected day of the week;
and a power unit for providing power to said control unit, said display unit and said alarm unit.

18. An alarm clock apparatus in claim 17, wherein said first selected day of a week is a Weekday, and wherein said second selected day of a week is a Saturday or Sunday.

19. An alarm clock apparatus in claim 17, further comprising a third button of said plurality of buttons for selecting a third alarm time on an hour and minute basis on a third selected day of a week, wherein said control unit stores said third selected alarm time on an hour and minute basis on said third selected day of a week, and controls said alarm unit for providing a third audible alarm at said third selected alarm time on said third selected day of a week.

20. An alarm clock apparatus in claim 19, wherein said first selected day of a week is a Weekday; wherein said second selected day of a week is a Saturday; and wherein said third selected day of a week is a Sunday.
